(19) United States
(12) Patent Application Publication
(10) Pub. No.: US 2005/0125836 A1
(43) Pub. Date: Jun. 9, 2005

(54) Shared wireless video downloading

(76) Inventors: Leonardo William Estevez, Rowlett, TX (US); William Michael Bommersbach, Richardson, TX (US); Ian James Sherlock, Dallas, TX (US)

Correspondence Address: J. Dennis Moore;Texas Instruments Incorporated, M/S 3999, P.O. Box 655474, Dallas, TX, 75265, US

(21) Appl. No.: 10/729,093

(22) Filed: Dec. 5, 2003

(51) Int. Cl. H04N 7/173

(52) U.S. Cl. 725/105

(57) ABSTRACT

An access point (210) equipped with a storage medium (220) and configured to buffer video streams (315, 320) can efficiently manage the amount of bandwidth consumed by wireless video clients (140) accessing the same video at the same access point, thereby reducing the impact on service to coexistent wireless users (130) of that access point.

### FIELD OF THE INVENTION

The invention relates generally to wireless communication networks and, more particularly, to video downloading in wireless networks.

### BACKGROUND OF THE INVENTION

In a wireless local area network (“WLAN”), an access point is a station that transmits and receives data (sometimes referred to as a transceiver). An access point connects users to other users within the network and also can serve as the point of interconnection between the WLAN and a fixed wire network. Each access point can serve multiple users within a defined network area (i.e., a finite range). As people move beyond the range of one access point, they are automatically handed over to the next one. Access points are actually the “hub” of a wireless network. With the access point connected to a wired network, everyone on the wireless network communicates through this access point to the rest of the world. A small WLAN may only require a single access point. The number of access points required increases as a function of the number of network users and the physical size of the network.

Multimedia applications, such as streaming video broadcasts, rely on the efficient transmission of compressed video from a video server to a client. However, compressed video traffic can be “bursty.” Therefore, buffering is used to temporarily hold data packets in order to give a “smooth” and continuous appearance to the video presentation. Additionally, buffering can free the processor to perform other tasks by minimizing the number of calls for data it must make. In an on-demand video server environment, clients make requests for movies to a centralized video server. Due to the stringent response time requirements, continuous delivery of a video stream to the client has to be guaranteed by reserving sufficient resources required to deliver a stream. Hence there is a hard limit on the number of streams that can be simultaneously delivered by a server. Such video servers are currently used in wired networks. However, if wireless users access these video servers through an access point, the amount of bandwidth consumed by the video traffic reduces the amount of bandwidth available for other wireless users attempting to use the same access point, thereby degrading the service to all the wireless users.

It is therefore desirable to provide a solution that enables wireless users to view streaming video through an access point without unacceptably degrading the service to coexistent wireless users of the same access point. According to exemplary embodiments of the invention, an access point is equipped with a storage medium and configured to buffer the video streams. Such an access point can efficiently manage the amount of bandwidth consumed by its wireless video clients, thereby reducing the impact on service to its other coexistent wireless users.

### BRIEF DESCRIPTION OF THE DRAWINGS

The above and further advantages of the invention may be better understood by referring to the following description in conjunction with the accompanying drawings in which corresponding numerals in the different figures refer to the corresponding parts, in which:

FIG. 1 diagrammatically illustrates an exemplary wireless communication system in accordance with the known art;

FIG. 2 diagrammatically illustrates a wireless communication system in accordance with exemplary embodiments of the present invention;

FIG. 3 diagrammatically illustrates video streaming in accordance with exemplary embodiments of the present invention;

FIG. 4 diagrammatically illustrates convergence windows in accordance with exemplary embodiments of the present invention;

FIG. 5 illustrates a flow diagram of operations in accordance with exemplary embodiments of the present invention; and

FIG. 6 diagrammatically illustrates exemplary embodiments of an access point server in accordance with the present invention.

### DETAILED DESCRIPTION

While the making and using of various embodiments of the present invention are discussed herein in terms of video servers, it should be appreciated that the present invention provides many inventive concepts that can be embodied in a wide variety of contexts. The specific embodiments discussed herein are merely illustrative of specific ways to make and use the invention, and are not meant to limit the scope of the invention.

The present invention enables wireless users to view streaming video through an access point without degrading the service to coexistent wireless users of the same access point. An access point equipped with a storage medium and configured to buffer the video streams can efficiently manage the amount of bandwidth consumed by its wireless video clients, thereby reducing the impact on service to its other coexistent wireless users. Exemplary embodiments of the present invention enable a single video stream to serve video data to multiple clients.

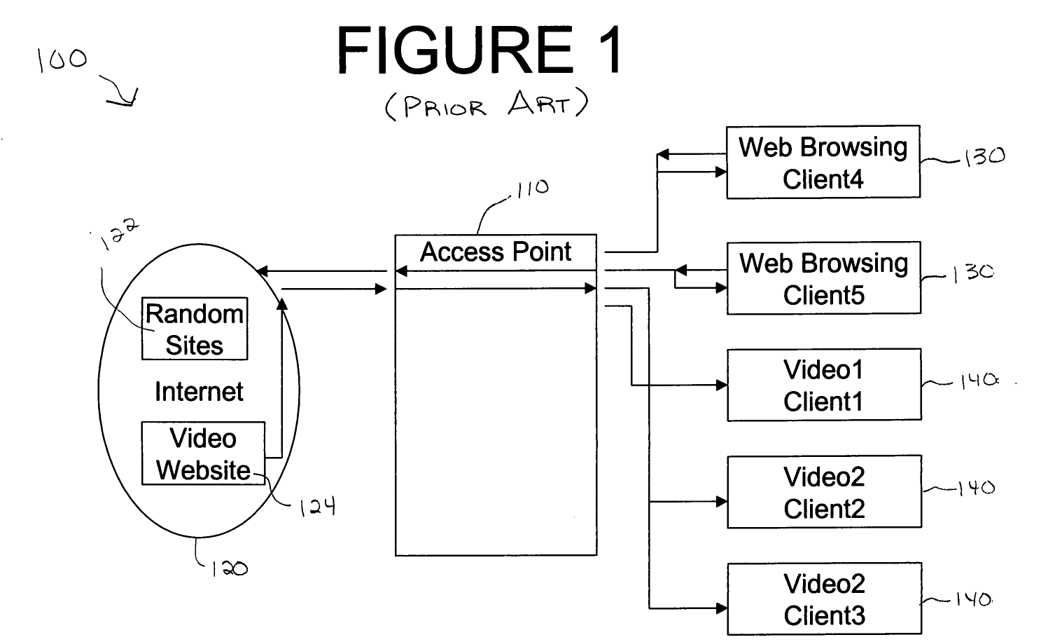

In the conventional wireless communication system 100 of FIG. 1, access point 110 wirelessly connects wireless users (e.g., web browsing clients 130 and video clients 140) to Internet (or any data network) 120. While web browsing clients 130 view random sites 122 on Internet 120, video clients 140 view videos provided by servers at video website 124. In FIG. 1, random sites 122 represent multiple websites of various types and video website 124 represent multiple websites dedicated to serving videos. Additionally, there may be more wireless users than illustrated in FIG. 1. In this configuration, the bandwidth consumed by video clients 140 can easily degrade the ability of web browsing clients 130 to access random sites 122 through access point 110.

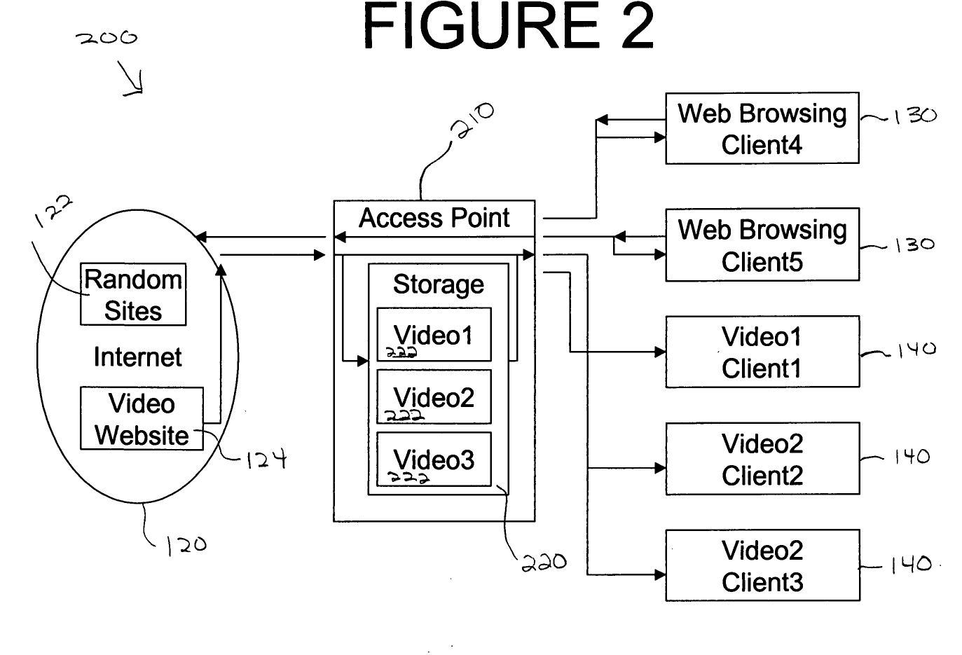

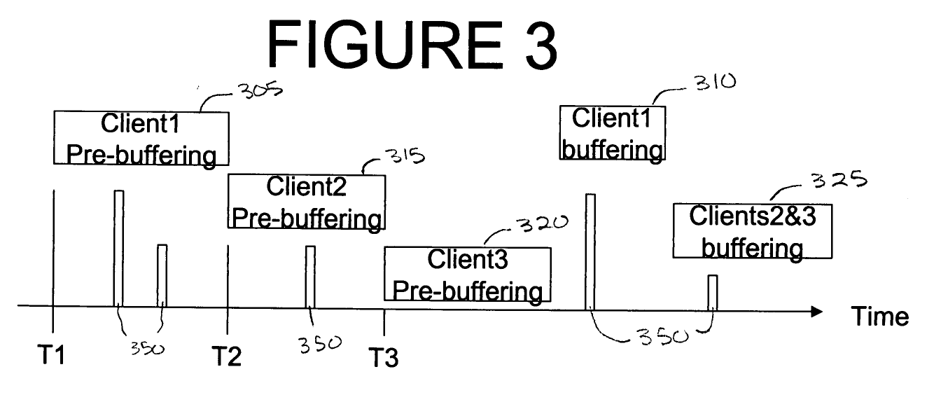

FIG. 2 diagrammatically illustrates exemplary embodiments of a wireless communication system 200 in accordance with the present invention. Access point 210 provides a wireless connection to Internet 120 for wireless users, such as web browsing clients 130 and video clients 140, but includes storage 220 where videos 222 (e.g., conventional video files) can be stored locally. In some exemplary embodiments, storage 220 includes conventional components such as an integrated disk or flash drive capable of buffering and serving multiple video streams. The use of storage 220 can decrease the amount of bandwidth consumed between access point 210 and Internet 120 by storing and buffering videos 222 locally. The number of videos 222 stored and served locally can be predetermined based on available bandwidth and storage capabilities. Additionally, local storage of videos 222 can enable pre-buffering (described below with reference to FIG. 3). In some exemplary embodiments, videos 222 are selected for local storage by service providers. In some exemplary embodiments, videos that are most frequently requested by clients are selected for local storage.

The amount of bandwidth consumed between access point 210 and wireless clients 130 and 140 can be decreased through the use of video streaming as illustrated in the exemplary embodiment of FIG. 3. Multiple video requests can be handled independently until multiple clients request the same stream. In FIG. 3 at time T1, a first video client (client 1) requests a video. Video data can then be pre-buffered from an access point, such as access point 210, to the disk drive of the first video client. During pre-buffering periods, such as 305, requests by other wireless users (e.g., web browsing requests 350) can still be efficiently processed. In some embodiments, pre-buffering to the disk drive of a video client can continue until a predetermined amount of video data has been pre-buffered or until another video client requests the same video.

In FIG. 3 at time T2, a second video client requests a video that is different from the video requested by the first video client (client 2) and pre-buffering period 315 begins. At time T3, a third video client (client 3) requests the same video that was requested by the second video client and pre-buffering period 320 begins. As illustrated in the exemplary embodiment of FIG. 3, when pre-buffering period 320 begins, pre-buffering period 315 ends. Pre-buffering of the third client occurs at a “catch up” rate designed to get the third client to the same point in transmission as the second client as quickly as possible. In some exemplary embodiments, a video that is already being pre-buffered to a given video client can also be pre-buffered to one or more subsequent video clients until the subsequent video client(s) reach the same point in transmission as the original video client. At that point, all viewers of the same video can be either simultaneously pre-buffered or buffered from a single video stream. In the exemplary embodiment illustrated in FIG. 3, buffering 310 can supply the first video to the first client and buffering 325 can supply the second video to both the second and third clients because the pre-buffering at 315 and 320 has brought the second and third video clients to the same point in transmission of the second video, even though each client may be at a different point in time in viewing the video. As other video clients (not shown) make video requests, the same type of pre-buffering operation occurs.

The access point can be configured to track the amount of data pre-buffered to each client in order to enable the video streams to reach a point of intersection (or synchronization) in time, thereby enabling broadcast transmission of the video packets to more than one client. By sharing a single video stream among several clients and managing the number of videos available, the amount of bandwidth consumed by video clients at a given access point can be maintained at a controllable level. In some embodiments, the video packets can have some form of encryption to prevent other wireless clients from intercepting the video stream.

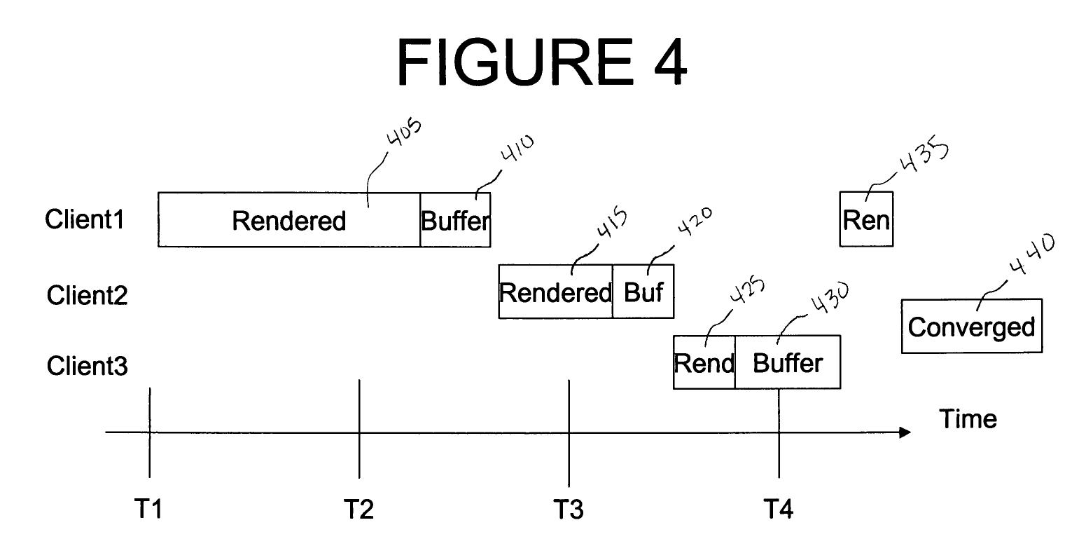

In some exemplary embodiments, when multiple video clients request the same video at different points in time, some later requests for the video will occur at a point in time too far into the transmission of the video to efficiently pre-buffer the later requests in order to synchronize them with earlier requests. In such embodiments, a new client video stream can be started if bandwidth is available. The determination of whether to serve video clients from a single video stream or start a new video stream can be made based on the amount of data that is left as well as the amount of time that it would take for later requests to catch up. In some embodiments, two or more video clients of a single video can be served from a single video stream (“synchronized”) if their individual requests occur within a single predetermined time period (“convergence window”). FIG. 4 diagrammatically illustrates convergence windows in accordance with exemplary embodiments of the present invention.

In the embodiment illustrated in FIG. 4, three (3) clients (Client1, Client2, and Client3) are requesting the same video, but at different times. Convergence windows fall between each time period designator such that a first convergence window exists between T1 and T2, a second convergence window exists between T2 and T3, a third convergence window exists between T3 and T4, and a fourth convergence window exists between T4 and some future point in time (not shown). In some embodiments, any subset of the illustrated set of convergence windows can be of identical duration. As illustrated in FIG. 4, Client1 requests a video at time T1. The video is rendered (405), or pre-buffered, during first convergence window (T1-T2) and partially into second convergence window (T2-T3). Buffering (410) of the video to Client1 also begins during second convergence window (T2-T3). By the time Client2 requests the same video, also during second convergence window (T2-T3), Client1 has received so much of the video that the time disparity between Client1 and Client2 is too large (a predetermined amount) to gain any benefit from attempting to synchronize the video stream between them. In other words, convergence between Client1 and Client2 of the client video stream currently being served to Client1 would not be attempted. A new client video stream of the same video can be served to Client2. The video can be rendered (415), or pre-buffered, and then buffered (420) to Client2, beginning during second convergence window (T2-T3) and continuing into third convergence window (T3-T4). Client3 is illustrated as requesting the same video during third convergence window (T3-T4). Because the time disparity between Client2 and Client3 during a single convergence window is not in excess of a predetermined amount, convergence, or synchronization, of a single video stream to Client2 and Client3 is possible. Therefore, the video can be rendered (425), or pre-buffered, to Client3 as described above with reference to FIG. 3 and then buffered (430) to Client3, beginning during third convergence window (T3-T4) and overlapping into fourth convergence window (beginning at T4). Therefore, Client2 and Client3 can be served from a single video stream. It may also be possible to synchronize a subsequent video client, requesting the same video (435) during fourth convergence window (beginning at T4) with Client2 and Client3 if the time disparity between the subsequent video client and the last requesting video client (Client3 in FIG. 4) does not exceed the predetermined amount. Convergence of the video, or serving multiple clients from a single video stream, between Client2, Client3, and a subsequent video client is illustrated as 440 in FIG. 4.

In some embodiments, the predetermined amount of time disparity is a static amount of time, for example a time disparity of one hour and 30 minutes between first and second client requests for the same video may preclude synchronization (i.e., falling out of the convergence window). In some embodiments, the predetermined amount is a dynamic amount of time based on a static percentage, for example a time disparity of eighty percent (80%) of a video already prebuffered to a first client when a second client requests the same video may preclude synchronization (i.e., falling out of the convergence window).

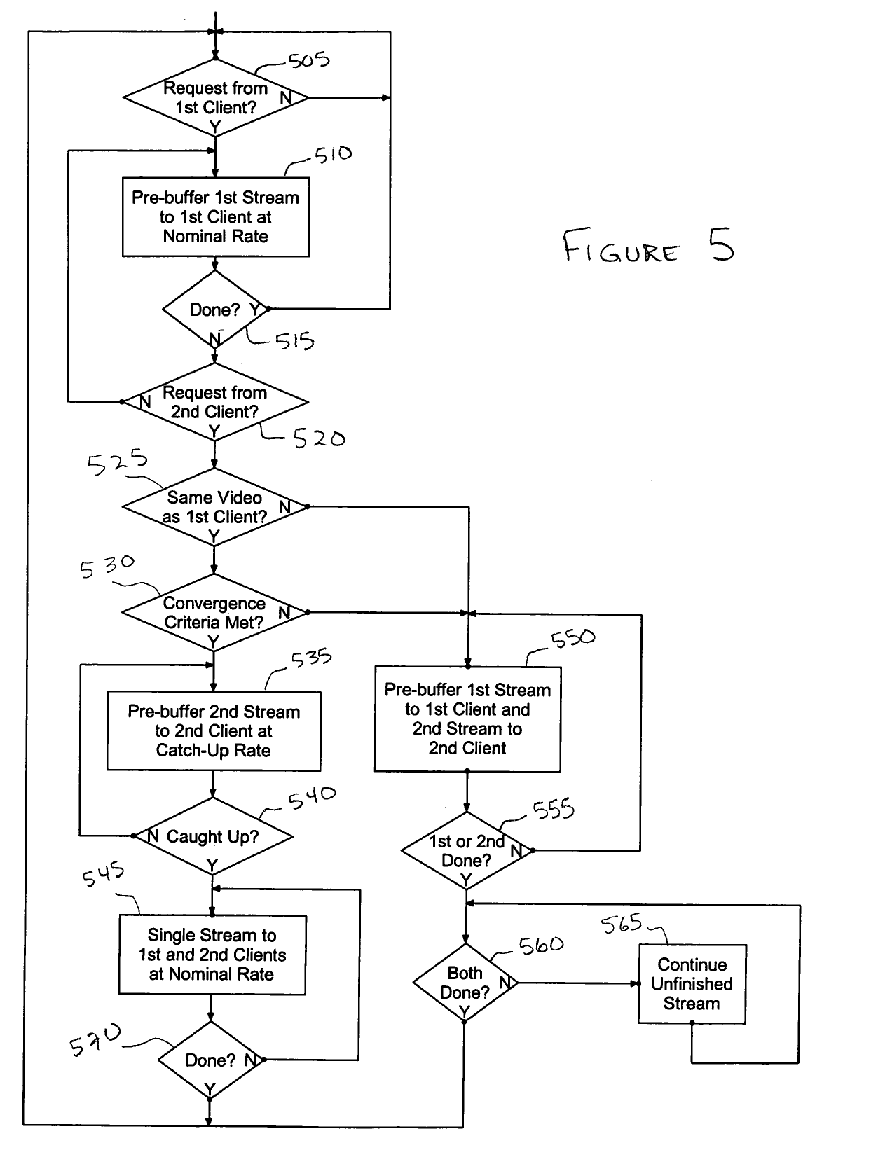

FIG. 5 illustrates a flow diagram of operations in accordance with exemplary embodiments of the present invention. When an access point (e.g., 210 in FIG. 2) receives a request from a first video client at 505, then at 510, a first video stream is pre-buffered to the first client (e.g., wirelessly transmitted to the first client's file storage) at a nominal rate. If at 515 and 520 a second video client requests a video during the pre-buffering of the first stream to the first client, and if it is determined at 525 that the second client has requested a different video than the video currently being pre-buffered to the first client, then at 550, pre-buffering of the first stream to the first client continues and pre-buffering of the second stream to the second client begins. Until pre-buffering to at least one of the clients is finished at 555, operations continue at 550. Once pre-buffering to either client is finished at 555, pre-buffering of the unfinished stream continues at 565. When pre-buffering of both streams has been completed at 560, operations return to 505.

If it is determined at 525 that the second client has requested the same video as the video currently being pre-buffered to the first client, and if the convergence criterion is met at 530, then at 535, a second stream is pre-buffered to the second client at a catch-up rate, which is, in some embodiments, higher than the nominal rate. In some embodiments, pre-buffering of the first stream to the first client (see 510) ends when pre-buffering of the second stream to the second client begins at 535. Pre-buffering to the second client continues until the second client has caught-up to the first client at 540, after which a single, common stream can be sent (i.e., broadcasted) at 545 to both the first and second clients at the nominal rate. Once the stream has finished at 570, operations return to 505.

If the convergence criterion is not met at 530, then operations proceed at 550 as described above.

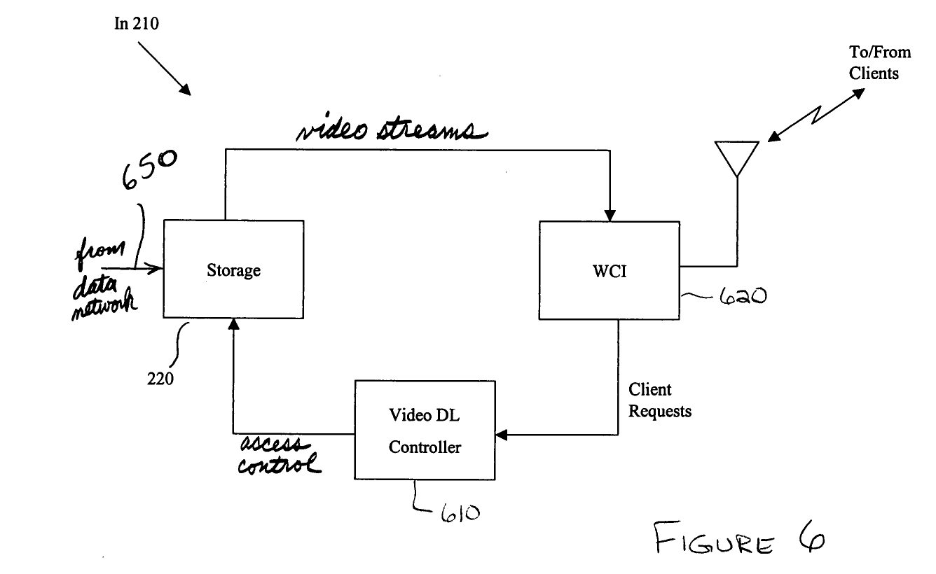

FIG. 6 diagrammatically illustrates exemplary embodiments of an access point server, such as access point 210, in accordance with the present invention. Clients communicate with access point 210 through a conventional wireless communication interface (“WCI”) 620. A video download (DL) controller 610 receives client requests via WCI 620. In some embodiments, the controller 610 manages video requests and streams according to a process such as that illustrated by the exemplary flow diagram of FIG. 5. Storage 220 stores video files received from a data network via a conventional interface 650, and controller 610 accesses storage 220 to supply video streams to WCI 620 for wireless transmission to the clients. Storage 220 and controller 610 thus constitute a video stream source that provides WCI 620 with video data streams from video files in response to client requests.

It will be evident to workers in the art that the exemplary embodiments described above with respect to FIGS. 2-6 can be readily implemented by suitable modifications in software, hardware or a combination of software and hardware in conventional access point servers.

Although exemplary embodiments of the present invention have been described in detail, it will be understood by workers in the art that various modifications can be made therein without departing from the spirit and scope of the invention as set forth in the appended claims.

1. An access point apparatus, comprising:
a data network interface for obtaining video files from a data network;
a file storage medium coupled to said data network interface for storing said video files; and
a wireless communication interface coupled to said file storage medium for transmitting said video files to video clients via a wireless communication link.

2. The apparatus of claim 1, wherein said video files are selected by a service provider for storage in said storage medium.

3. The apparatus of claim 1, wherein said video files are selected for storage in said storage medium based on client requests for said video files.

4. The apparatus of claim 3, wherein said video files stored in said file storage medium are requested by clients more frequently than other video files available in the data network.

5. The apparatus of claim 1, provided as an access point server for a WLAN.

6. A method for wireless transmission of video data to wireless communication devices, comprising:
wirelessly transmitting to a first wireless communication device a first stream of data from a video file;
during said transmitting step, receiving from a second wireless communication device a request for said video file;
in response to said request, wirelessly transmitting to the second wireless communication device a second stream of data from said video file; and
after said last-mentioned transmitting step, wirelessly transmitting to both the first and second wireless communication devices a common stream of data from said video file.

7. The method of claim 6, wherein said step of wirelessly transmitting said second stream of data includes wirelessly transmitting said second stream of data at a higher transmission rate than said first stream of data.

8. The method of claim 7, wherein said step of wirelessly transmitting said second stream of data includes wirelessly transmitting said second stream of data at a higher transmission rate than said common stream of data.

9. The method of claim 8, wherein said steps of wirelessly transmitting said first and common streams of data include wirelessly transmitting said first stream of data and said common stream of data at a mutually common transmission rate.

10. The method of claim 7, including commencing said step of wirelessly transmitting said common stream of data in response to a determination that said second stream of data has reached a same data position in said video file as said first stream of data.

11. The method of claim 10, including ending said first stream of data upon commencement of said step of wirelessly transmitting said second stream of data.

12. The method of claim 6, including performing said step of wirelessly transmitting said common stream of data in response to a predetermined condition.

13. The method of claim 12, wherein a portion of said video file has already been transmitted in said first stream of data when said request is received, and wherein said predetermined condition is that said portion of said video file is less than a predetermined fraction of said video file.

14. The method of claim 13, wherein said predetermined fraction is 80%.

15. The method of claim 12, including performing said first-mentioned transmitting step in response to receipt of a further request for said video file from the first wireless communication device, and wherein said predetermined condition is that said request is received less than a predetermined amount of time after receipt of said further request.

16. The method of claim 15, wherein said amount of time is 1.5 hours.

17. The method of claim 6, including commencing said step of wirelessly transmitting said common stream of data in response to a determination that said second stream of data has reached a same data position in said video file as said first stream of data.

18. The method of claim 17, including ending said first stream of data upon commencement of said step of wirelessly transmitting said second stream of data.

19. A wireless communication apparatus, comprising:
a wireless communication interface for permitting wireless communication with wireless communication devices;
a video stream source having an output coupled to said wireless communication interface for providing to said wireless communication interface streams of data from a video file, said wireless communication interface cooperable with said video stream source for wirelessly transmitting to a first wireless communication device a first stream of data from said video file;
said video stream source having an input coupled to said wireless communication interface for receiving from a second wireless communication device, during said wireless transmission of said first stream of data, a request for said video file, said video stream source and said wireless communication interface cooperable in response to said request for wirelessly transmitting to the second wireless communication device a second stream of data from said video file; and
said video stream source cooperable with said wireless communication interface, after transmission of said second stream of data to the second wireless communication device, for wirelessly transmitting to both the first and second wireless communication devices a common stream of data from said video file.

20. The apparatus of claim 19, including a data network interface for obtaining said video file from a data network, said video stream source coupled to said data network interface.

21. The apparatus of claim 20, wherein said video stream source includes a file storage medium for storing said video file.

22. The apparatus of claim 19, provided as an access point server for a WLAN.
